(19) United States
(12) Patent Application Publication
(10) Pub. No.: US 2022/0071826 A1
(43) Pub. Date: Mar. 10, 2022

(54) URINE STORAGE CONTAINER HANDLE AND LID ACCESSORIES

(71) Applicant: PureWick Corporation, El Cajon, CA (US)

(72) Inventors: Vinayaka Kulkarni, Bangalore (IN); Claire Gloeckner, Lilburn, GA (US); Seth Schneider, Social Circle, GA (US); Hannah Rose Kriscovich, Marietta, GA (US)

(21) Appl. No.: 17/461,036

(22) Filed: Aug. 30, 2021

Related U.S. Application Data
(60) Provisional application No. 63/076,477, filed on Sep. 10, 2020.

(51) Int. Cl. A61G 9/00

(52) U.S. Cl. CPC A61G 9/006; A61G 9/02

(57) ABSTRACT

Example urine storage assemblies and systems for storing and disposing urine are described. The assembly includes a urine storage container, a lid, and a handle accessory. The lid is secured or securable to an open end of the urine storage container. The lid includes a vacuum port, a urine collection port, a urine disposal port, and a cap secured or securable to the urine disposal port. The handle accessory includes a sleeve and at least one handle. The sleeve is shaped and sized complimentary to at least a portion of the urine storage container.

### CROSS-REFERENCE TO RELATED APPLICATIONS

This application claims priority to U.S. Provisional Patent Application No. 63/076,477 filed on Sep. 10, 2020, the disclosure of which is incorporated herein, in its entirety, by this reference.

### BACKGROUND

Portable vacuums and urine storage containers are used to pull urine and other fluids from urine collection devices for storage in the urine storage containers. When full, these urine storage containers can be heavy and cumbersome for caregivers to transport and empty for disposal of the fluid. Undesirable spilling of the contents of the fluid collection device may occur during movement of the fluid collection containers.

Thus, users and manufacturers of fluid storage systems continue to seek new and improved devices, systems, and methods to collect and dispose of urine.

### SUMMARY

Embodiments disclosed herein are urine storage container handle and/or lid accessories, and systems and methods including urine storage container handle and/or lid accessories. In an embodiment, a fluid storage assembly for storing and disposing of urine collected from a user includes a urine storage container, a lid, and a handle accessory. The urine storage container configured to store urine collected from the user and having an open end and a closed end distal to the open end. The lid is secured or securable to the open end of the urine storage container. The lid includes a vacuum port configured to attach to a vacuum conduit in fluid communication with a vacuum source, a urine collection port configured to attach to a urine collection conduit in fluid communication with a urine collection device such that urine collected from the user enters the urine storage container through the urine collection port when the vacuum source is activated, a urine disposal port sized and dimensioned to pour urine in the urine storage container therethrough when the lid is secured to the urine storage container, and a cap secured or securable to the urine disposal port. The handle accessory includes a sleeve and at least one handle. The sleeve is shaped and sized complimentary to at least a portion of the urine storage container.

In an embodiment, a urine storage system for storing and disposing of urine collected from a user includes a urine storage container, a lid, a vacuum conduit, and a urine collection conduit. The urine storage container at least partially defines a chamber configured to store urine collected from the user and having an open end and a closed end distal to the open end. The lid is secured or securable to the open end of the urine storage container. The lid includes a vacuum port, a urine collection port, a urine disposal port sized and dimensioned to pour the urine in the urine storage container therethrough when the lid is secured to the urine storage container, and a cap secured or securable to the urine disposal port. The vacuum conduit is in fluid communication with a vacuum source and attached to the vacuum port effective to provide fluid communication between the vacuum source and the chamber of the urine storage container. The urine collection conduit is in fluid communication with a urine collection device and attached to the urine collection port effective to provide fluid communication between the chamber and the urine collection device such that urine collected from the user enters the chamber of the urine storage container through the urine collection port when the vacuum source is activated.

In an embodiment, a method of assembling a urine storage system for storing and disposing of urine collected from a user is described. The method includes securing a lid to an open end of a urine storage container at least partially defining a chamber configured to store urine collected from a user. The lid includes a vacuum port, a urine collection port, a urine disposal port sized and dimensioned to pour the urine in the urine storage container therethrough, and a cap secured to the urine disposal port. The method also includes securing a vacuum conduit to the vacuum port on the lid effective to provide fluid communication between a vacuum source and the chamber of the urine storage container. The method also includes securing a urine collection conduit to the urine collection port effective provide fluid communication between a urine collection device and the chamber such that urine collected from the user enters the chamber of the urine storage container through the urine collection port when the vacuum source is activated.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1A is an isometric view of a urine storage system including a portable vacuum, a urine storage container, a urine storage container handle accessory, and a lid, according to an embodiment.

FIG. 1B is an isometric view of the urine storage container handle accessory of FIG. 1A.

FIG. 1C is an isometric view of the urine storage container handle accessory and the lid of FIG. 1A in use.

FIG. 2 is an isometric view of a urine storage container handle accessory, according to an embodiment.

FIG. 3A is an isometric view of a urine storage container handle accessory with handles in a first position, according to an embodiment.

FIG. 3B is an isometric view of the urine storage container handle accessory of FIG. 3A with the handles in a second position.

FIG. 3C is an isometric view of the urine storage container handle accessory of FIG. 3A in use.

FIG. 4 is an isometric view of a urine storage container handle accessory, according to an embodiment.

FIG. 5A is an isometric view of a urine storage container handle accessory with a handle in a first position, according to an embodiment.

FIG. 5B is an isometric view of the urine storage container handle accessory of FIG. 5A with the handle in a second position.

FIG. 5C is an isometric view of the urine storage container handle accessory of FIG. 5A in use.

FIG. 6A is a partial cross-sectional view of a urine storage container handle accessory and a urine storage container, according to an embodiment.

FIG. 6B is a partial cross-sectional view of a urine storage container handle accessory and a urine storage container, according to an embodiment.

FIG. 6C is an isometric view of a urine storage container handle accessory, according to an embodiment.

FIG. 7 is a block diagram of a system for urine storage, according to an embodiment.

FIG. 8 is a flow diagram of a method of assembling a urine storage system for storing and disposing of urine collected from a user.

### DETAILED DESCRIPTION

Portable vacuums and urine storage containers or canisters are used to pull urine and other fluids from urine collection devices for storage in the urine storage containers. Conventional urine containers typically do not include a handle, and the urine storage container can be heavy and cumbersome for caregivers to carry without a handle for emptying and disposal of the urine. The urine storage container handle accessories described herein are configured to secure to a urine storage container for easier and safer transport of the urine storage container when the urine storage container contains urine or other fluids. In some embodiments, a urine storage container handle accessory at least partially wraps around at least a top portion of a urine storage container under a rim or lip on the urine storage container. The handle accessory can remain on the urine storage container while the container is in use (collecting fluids). Once tubing is disconnected from the lid of the storage container, the storage container may be lifted straight up out of the portable vacuum base with the handle accessory and carried away for disposal of the urine.

Additionally, conventional lids for urine storage containers must be completely removed from the storage container before the storage container can be emptied. Removing the lid from the storage container requires enough force to frequently cause urine to spill from the storage container during the process. Moreover, when the entire lid is removed from the storage container, there is a higher risk that all of the urine may be spilled from the storage container if the user/caregiver drops the storage container. When the entire lid is removed from the storage container, there also is a higher risk that urine sloshes out of the storage container on the way to empty the storage container. Described herein are embodiments of one or more lids for urine storage containers that include a urine disposal port on the lid that allows urine to be removed from the storage container without removing the lid. In use, a user/caregiver may remove a cap from the urine disposal port on the lid and pour the urine out of the storage container through the urine disposal port without removing the lid. The cap may be easy to remove and reattach to the urine disposal port. The cap may include an overhanging flap that allows the user/caregiver to either push the tab to open the urine disposal port or allows the user/caregiver to grasp the cap to open the urine disposal port.

This urine disposal port also may be used to introduce a cleaning solution into the storage container to clean the storage container between uses. For example, after pouring the urine out of the storage container, water with soap or another cleaning agent can be poured into the storage container through the urine disposal port to clean in the inside of the storage container and the lid between uses. After the inside of the container is cleaned, the cleaning solution and water can then be dumped out of the storage container through the urine disposal port.

The urine storage container handle and lid accessories described herein may be used in urine storage systems. The fluid storage systems may include a fluid collection device, a fluid storage container, and a portable vacuum source. Fluid (e.g., urine or other bodily fluids) collected in the fluid collection device may be removed from the urine collection device via a conduit which protrudes into an interior region of the urine collection device. For example, a first open end of the conduit may extend into the urine collection device to a reservoir therein. The second open end of the conduit may extend into the fluid collection device or the portable vacuum source. The suction force may be introduced into the interior region of the fluid collection device via the first open end of the conduit responsive to a suction (e.g., vacuum) force applied at the second end of the conduit. The suction force may be applied to the second open end of the conduit by the portable vacuum source either directly or indirectly.

In some embodiments, the urine collection devices may be shaped and sized to be positioned adjacent to the opening of a female or male urethra. Embodiments of urine collection devices that may be used with embodiments of the urine storage systems disclosed herein are disclosed in International Application No. PCT/US19/29616 filed on Apr. 29, 2019; U.S. patent application Ser. No. 16/369676 filed on Mar. 29, 2019; and U.S. patent application Ser. No. 16/478180 filed Jul. 16, 2019, the disclosure of each of which is incorporated herein, in its entirety, by this reference. A conduit may extend into the urine collection device. In some embodiments, the portable vacuum source may be disposed in or on the urine collection device. In such embodiments, the conduit may extend from the urine collection device and attach to the portable vacuum source at a first point therein. An additional conduit may attach to the portable vacuum source at a second point thereon and may extend out of the urine collection device, and may attach to the fluid storage container. Accordingly, a vacuum (e.g., suction) may be drawn through the fluid collection device via the fluid storage container. Fluid, such as urine, may be drained from the fluid collection device using the portable vacuum source.

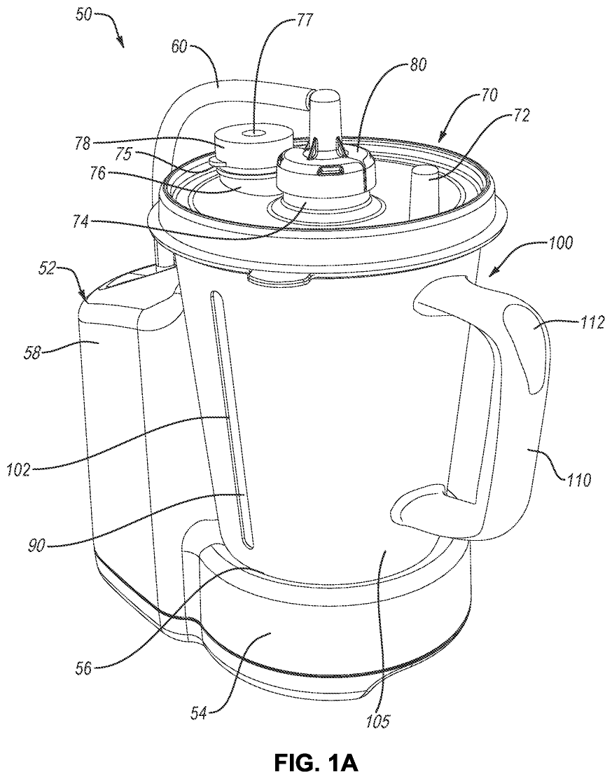

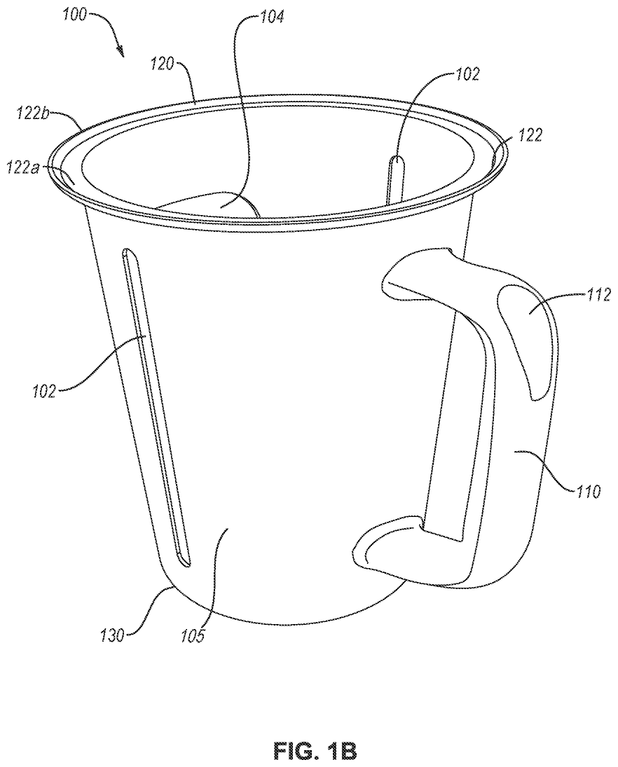

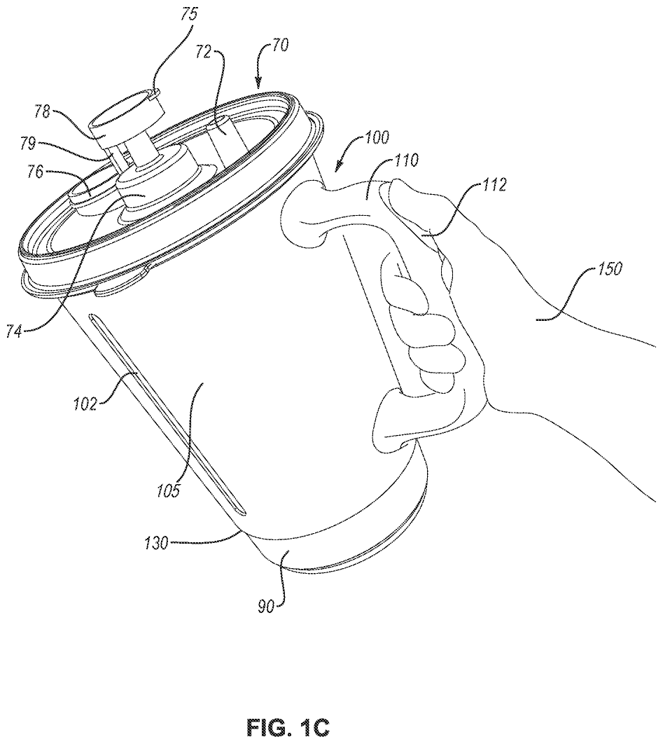

FIG. 1A is an isometric view of a urine storage system 50 including a portable vacuum system 52, a urine storage container handle accessory 100, a urine (or other fluid) storage container 90 (visible in FIG. 1A through an elongated opening 102 in the handle accessory 100), and a lid 70. The portable vacuum system 52 may include a housing holding a portable vacuum therein. For example, a portable vacuum may be housed in a body 58 of the portable vacuum system 52. The portable vacuum system 52 also may include a base 54 configured to receive a portion of the storage container 90. For example, the base 54 may include a recessed portion 56 shaped complementary to a portion of the storage container 90. FIG. 1C, for example, shows a bottom portion of the storage container 90 that may rest within the recessed portion 56 to station the storage container 90 on the base 54. The storage container 90 may at least partially define a chamber therein and include an open end and a closed bottom end (shown in FIG. 1C) distal to the open end. In some embodiments, the storage container 90 tapers between the open end and the closed end. For example, the storage container 90 may taper continuously or partially between the open end and the closed end. The storage container 90 may include a disposable storage container, such as a polypropylene storage container.

FIG. 1B is an isometric view of a urine storage container handle accessory 100 according to an embodiment. The handle accessory 100 includes a sleeve 105 having a first end region 120 and a second end region 130. The first end region 120 and the second end region 130 may both be open such that the storage container 90 can be inserted through the first end region 120 and the second end region 130. In some embodiments, the sleeve 105 may be sized such that the bottom closed end of the storage container 90 extends partially from the open second end region 130 of the sleeve 100 (shown in FIG. 1C). In many embodiments, the sleeve 105 tapers at least partially between the first end region 120 and the second end region 130 complementary to the storage container 90. For example, the sleeve 105 may taper continuously or partially between the first end region 120 and the second end region 130. The material of the sleeve 105 may include any of a variety of different materials, including plastic, rubber, metal, wood, or combinations thereof.

In some embodiments, the sleeve 105 includes at least one elongated opening 102 extending at least partially between the first end region 120 and the second end region 130. For example, the sleeve 105 includes two elongated openings 102 extending at least partially between the first end region 120 and the second end region 130. The elongated opening is positioned on the sleeve 105 to allow a user or caregiver to view the contents in the storage container 90. For example, a user or caregiver may desire to know an approximate volume of fluids in the storage container 90 or how full the storage container 90 is. A user or caregiver also may desire to know general characteristics of the fluid in the storage container 90, i.e., if the urine is discolored, includes blood, etc. The elongated opening 102 in the sleeve 105 allows a user or caregiver to instantly view the contents in the storage container 90 even when the handle accessory 100 is positioned around the storage container 90, thereby allowing a user or caregiver to instantly assess the fluid in the storage container 90. In some embodiments, the elongated opening 102 includes a transparent or translucent material.

In some embodiments, the sleeve 105 includes an outer periphery and defines a gap 104 in the outer periphery extending longitudinally from the second end region 130 at least halfway to the first end region 120. The gap 104 in the sleeve 105 may extend at least about 45 degrees, at least about 60 degrees, or at least about 75 degrees on the outer periphery of the sleeve 105. The gap 104 may be positioned on the sleeve 105 to be adjacent to the body 58 of the portable vacuum system 52 and/or to accommodate a portion of the body 58 positioned adjacent to the storage container 90 when the storage container 90 is positioned in recessed portion 56.

The handle accessory 100 also includes a handle 110 secured or securable to the sleeve 105. The handle 110 may include a variety of configurations, such as a C- or U-shaped handle secured or securable to the sleeve 105 at two ends of the handle 110, an L-shaped handle secured or securable to the sleeve 105 at only one end, a handle pivotably or hingedly secured to the sleeve 105, or combinations thereof. The handle accessory 100 includes a C- or U-shaped handle 110 secured to the sleeve 105 at two ends of the handle 110. In some embodiments, one end of the handle 110 may be secured to the first end region 120 and another end of the handle 110 may be secured to the second end region 130. In some embodiments, the sleeve 105 is separated into two portions: a first portion at the first end region 120 secured to a first end of the handle 110 and a second portion at the second end region 130 secured to a second end of the handle 110.

The handle 110 may be positioned in various positions on the sleeve 105. For example, the handle 110 is positioned on the sleeve 105 between the two elongated openings 102 and generally distal or opposite to the gap 104. In other embodiments, the handle 110 may be positioned elsewhere on the sleeve 105. The handle 110 also may include a thumb-grip 112 on an outer surface of the handle 110, such as a top corner portion of the outer surface of the handle 110.

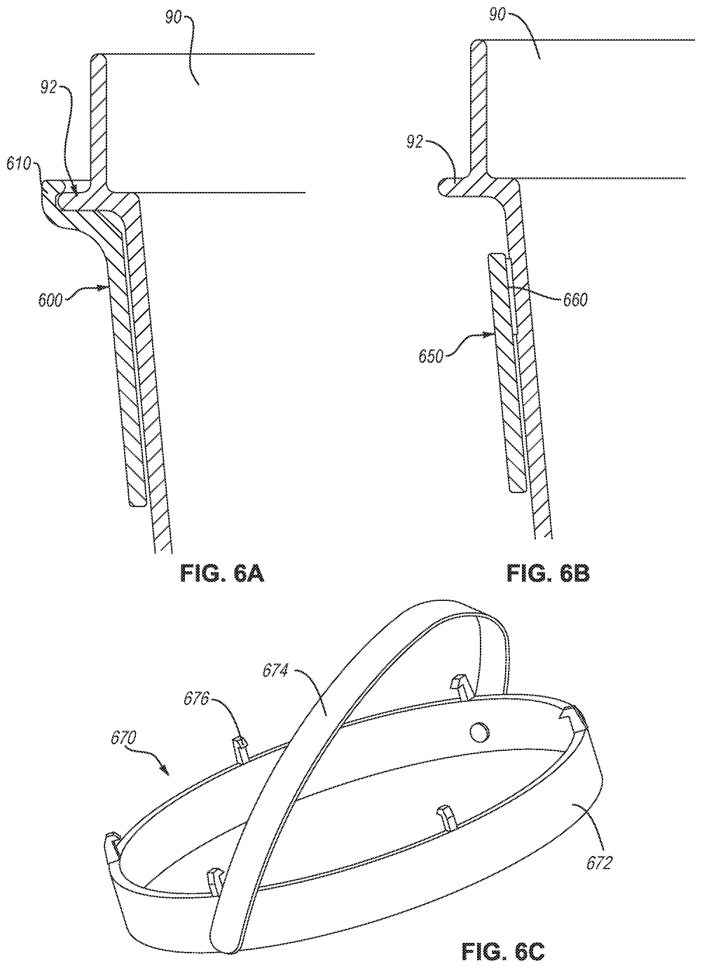

In some embodiments, storage container 90 includes an outward protruding lip or rim (shown in FIGS. 6A and 6B) proximate to the open end of the storage container 90. The handle accessory 100 may include an outward protruding flange 122 proximate to the first end region 120 positioned to at least partially interface the lip of the storage container 90. The flange 122 may include a first portion 122a adjacent to the sleeve 105 that interfaces the lip of the storage container 90. The flange 122 also may include a second portion 122b angled upward from the first portion 122a. The second portion 122b may be positioned to at least partially cover an outer periphery of the lip and/or guide the lip into position on the first portion 122a. The second portion 122b also may be used with a pivoting handle to lock the handle accessory to the storage container 90. In some embodiments, the flange 122 may be absent, and the sleeve 105 may include a locking tab configured to releasably secure to the lip of the storage container 90 and prevent the sleeve 105 from sliding down the storage container 90.

Returning to FIG. 1A, the urine storage system 50 also include a lid 70 detachably secured or securable to the open end of storage container 90. The lid 70 includes a first or urine collection port 72 configured to attach to a conduit to provide fluid communication between a urine collection device positioned on the user and the storage container 90. The lid 70 also includes a second or vacuum port 74 configured to attach to a conduit 60 to provide fluid communication between the vacuum in the portable vacuum system 52 and the urine storage container 90. An adapter 80 also may be secured or securable to the vacuum port 74, the adapter 80 being configured to attach directly to the conduit 60.

The lid 70 also includes an third or urine disposal port 76. The urine disposal port 76 may be positioned on the lid 70 spaced from the urine collection port 72 with the vacuum port 74 between the urine collection port 72 and the urine disposal port 76. In some embodiments, the vacuum port 74 may be positioned proximate to the urine disposal port 76, and the urine collection port 72 may be positioned at any other location on the lid 70. Other arrangements can also be used.

The urine disposal port 76 is sized to allow a user or caregiver to pour urine out of the storage container through the urine disposal port without removing the lid 70. The urine disposal port 76 also may be sized to allow easy and efficient introduction of a cleaning solution into the storage container 90 to clean the storage container 90 between uses. After the inside of the storage container 90 and/or the lid 70 is cleaned, the cleaning solution and water can then be dumped out of the storage container 90 through the urine disposal port 76. The urine disposal port 76 may be larger (e.g., have a greater diameter) than at least one (e.g., both) of the urine collection port 72 and the vacuum port 74. In some embodiments, the urine disposal port 76 has a diameter of at least about 0.5 inch, at least about 0.75 inch, at least about 1 inch, at least about 1.25 inches, at least about 1.5 inches, at least about 1.75 inches, at least about 2 inches, about 0.5 inch to about 2 inches, about 0.5 inch to about 1 inch, about 1 inch to about 1.5 inches, or about 1.5 inches to about 2 inches.

The lid 70 also may include a cap 78 removably secured or securable to the urine disposal port 76. FIG. 1A shows the cap 78 secured to the urine disposal port 76 in closed position such that the urine disposal port 76 is closed and fluid in the storage container 90 cannot pass through the urine disposal port 76. The cap 78 also may include a cavity 77 sized to receive and mate with a portion of the vacuum port 74 when the adapter 80 is removed from the vacuum port 74. For example, FIG. 1C shows the lid 70 with the cap 78 in the open position. When in the open position, the user or caregiver may prefer to keep the cap 78 from interfering with fluids being poured through the urine disposal port 76. The cap 78, then, may replace the adapter 80 and be detachably secured to the vacuum port 74 by inserting a portion of the vacuum port 74 into the cavity 77 of the cap 78, as shown in FIG. 1C. In FIG. 1C, the cavity 77 in the cap 78 holding a portion of the vacuum port 74 therein is facing downwards and not visible, while the portion of the cap 78 that receives the rim of the urine disposal port 76 is facing upwards and visible. When detachably secured to the vacuum port 74, the cap 78 also may prevent urine or other fluids from leaking out of the vacuum port 74 when the storage container 90 is tipped. A strap 79 may secure the cap 78 to the urine disposal port 76 when the cap 78 is in the open position, with the strap 79 either being secured directly to the urine disposal port 76 or removably secured to the urine disposal port 76 with an o-ring. The cap 78 may include an overhanging flap 75 that allows the user or caregiver to either push the tab to open the urine disposal port 76 or allows the user or caregiver to grasp the cap 78 to open the urine disposal port 76. In some embodiments, the cap 78 may include a flap pivotably secured to the lid 70.

To empty a storage container 70, the conduit 60 and a conduit fluidly coupling the storage container 90 to a fluid collection device are both disconnected from the lid 70. FIG. 1C also shows how a user or caregiver 150 may utilize the handle accessory 100 to transport a storage container 90, though during transport of the storage container 90, the cap 78 is typically in a closed position (shown in FIG. 1A). In FIG. 1C, the bottom end of the storage container 90 is visible extending from the second end 130 of the sleeve 105 and the storage container 90 is visible through the elongated opening 102 of the sleeve 105. The handle accessory 100 allows a user to grasp the handle 110 and more easily carry the storage container 90, which may be heavy if full of fluid. The handle accessory 100 also is beneficial to emptying the storage container 90, as the handle accessory 100 allows for a more controlled tipping of the storage container 90. With the cap 78 in the open position shown in FIG. 1C, urine and other fluids in the storage container may be emptied from the storage container 90 via the urine disposal port 76.

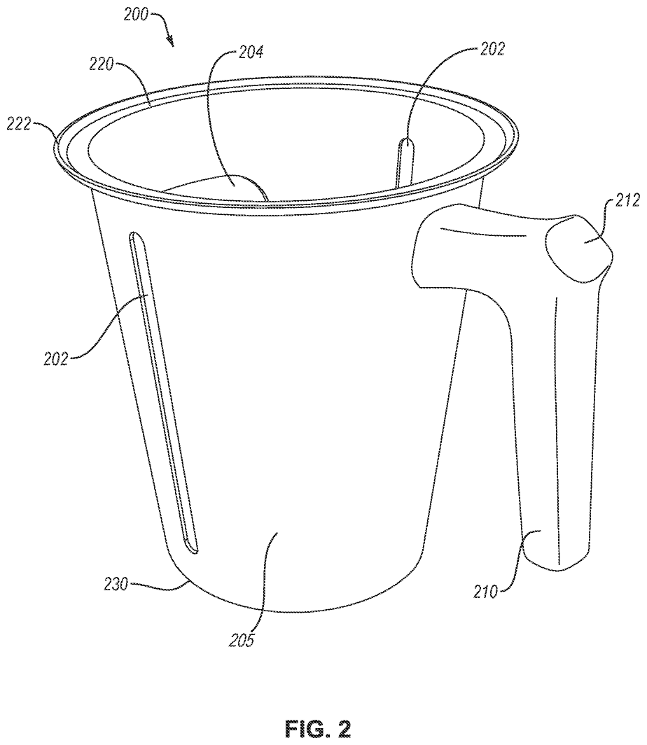

FIG. 2 is an isometric view of a handle accessory 200, according to an embodiment. Unless otherwise noted, the handle accessory 200 may include any aspect of the handle accessory 100 described above. For example, the handle accessory 200 includes a sleeve 205 having a first end region 220 and a second end region 230, elongated openings 202, a gap 204, and/or an outward protruding flange 222 that include aspects of the sleeve 105 having the first end region 120 and the second end region 130, the elongated openings 102, the gap 104, and/or an outward protruding flange 122 described above.

The handle accessory 200 also includes a handle 210. Unless otherwise noted, the handle 210 may include any aspect of the handle 110 described above. The handle 210 includes an L-shaped handle 210 secured to the sleeve 205 proximate to the first end region 220 of the sleeve 205. The handle 210 may be secured to the sleeve 205 between the two elongated openings 202 and generally opposite to the gap 204. The handle 210 also may include a thumb grip 212 on a corner of the handle 210.

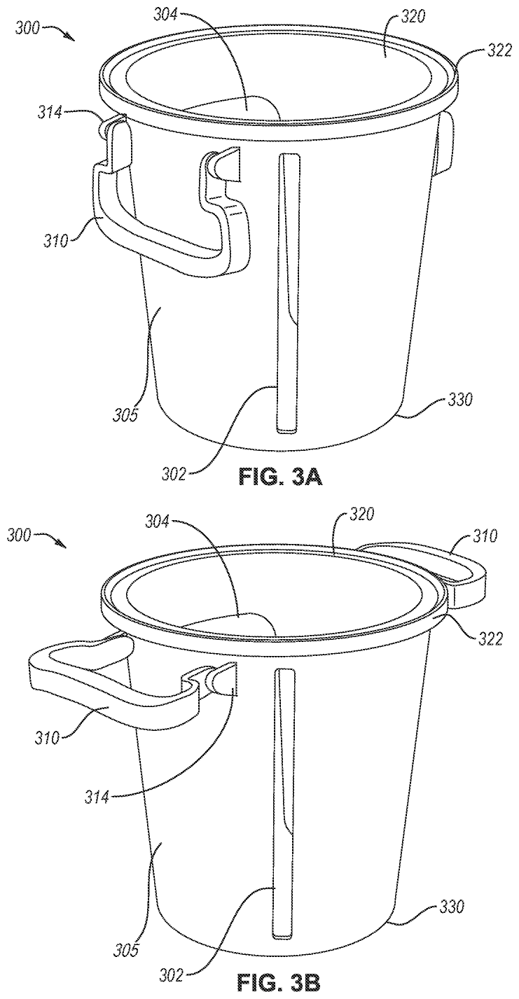

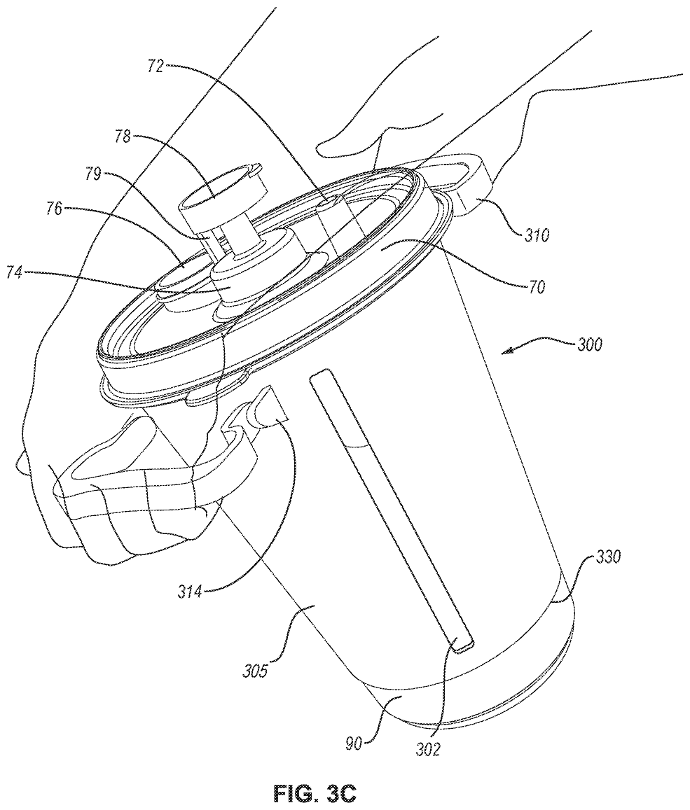

FIGS. 3A-3C are views of a handle accessory 300, according to an embodiment. Unless otherwise noted, the handle accessory 300 may include any aspect of the handle accessory 100 described above. For example, the handle accessory 300 includes a sleeve 305 having a first end region 320 and a second end region 330, an elongated opening 302, a gap 304, and/or an outward protruding flange 322 that include aspects of the sleeve 105 having the first end region 120 and the second end region 130, the elongated openings 102, the gap 104, and/or an outward protruding flange 122 described above.

The handle accessory 300 also includes two handles 310. Unless otherwise noted, the handles 310 may include any aspect of the handles 110, 210 described above. The handles 310 include two C- or U-shaped handles 310 pivotably or hingedly secured to supports 314 on opposing portions of the sleeve 305 proximate to the first end region 320 of the sleeve 305. Each handle 310 may be secured to the sleeve 305 between the elongated opening 302 and the gap 304. FIG. 3A shows the handles 310 in a downward position, or how the handles 310 may rest when the handle accessory 300 is mated with a storage container 90 on the portable vacuum system 52. FIG. 3B shows the handles 310 having pivoted to an angled position relative to the downward position shown in FIG. 3A. As shown in FIG. 3C, with the handles 310 in an angled position, a user or caregiver may use the handle accessory 300 to carry and/or tip the storage container 90. In some embodiments, the supports 314 and/or the handles 310 may include a tab configured to prevent the handles 310 from pivoting past a desired angled position. Though not shown in FIGS. 3A-3C, in some embodiments the handles 310 rotate to an upright position and may include one or more locking tabs (described in greater detail below in relation to the sleeve 500) configured to lock the lid 70 in place on the storage container 90.

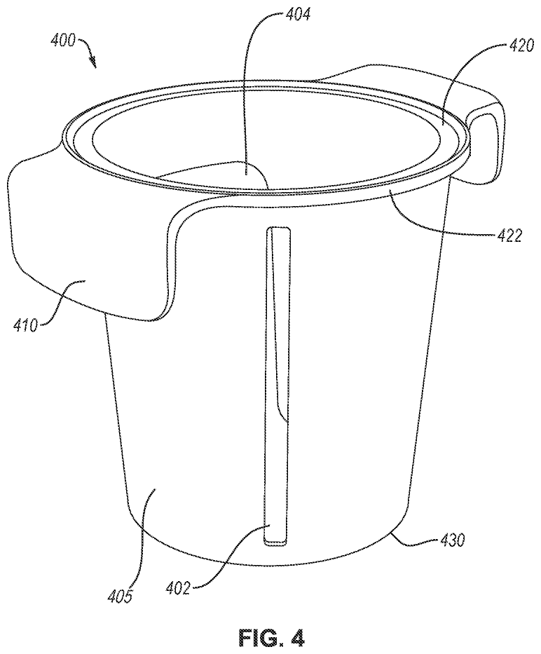

FIG. 4 is an isometric view of a handle accessory 400, according to an embodiment. Unless otherwise noted, the handle accessory 400 may include any aspect of the handle accessory 100 described above. For example, the handle accessory 400 includes a sleeve 405 having a first end region 420 and a second end region 430, elongated openings 402, a gap 404, and/or an outward protruding flange 422 that include aspects of the sleeve 105 having the first end region 120 and the second end region 130, the elongated openings 102, the gap 104, and/or an outward protruding flange 122 described above.

The handle accessory 400 also includes two handles 410. Unless otherwise noted, the handle 410 may include any aspect of the handles 110, 210, 310 described above. The handles 410 include an L-shaped handles 410 secured to the flange 422 of the sleeve 405 proximate to the first end region 420. Each handle 410 may be secured to the sleeve 405 between the elongated opening 402 and the gap 404.

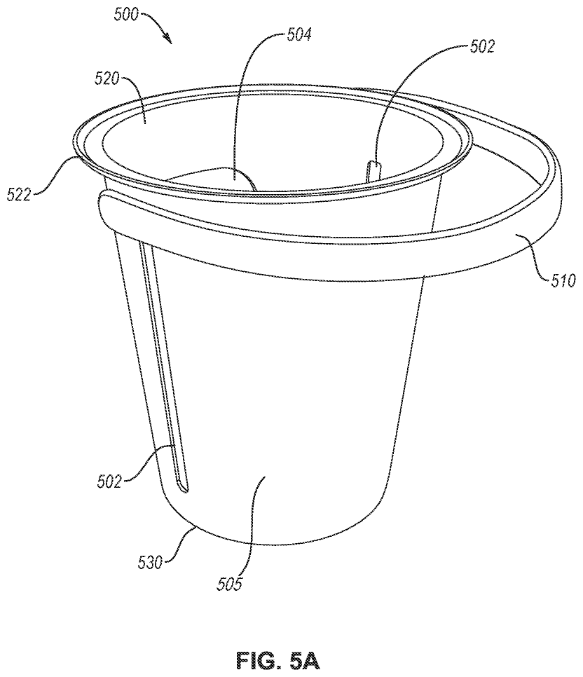

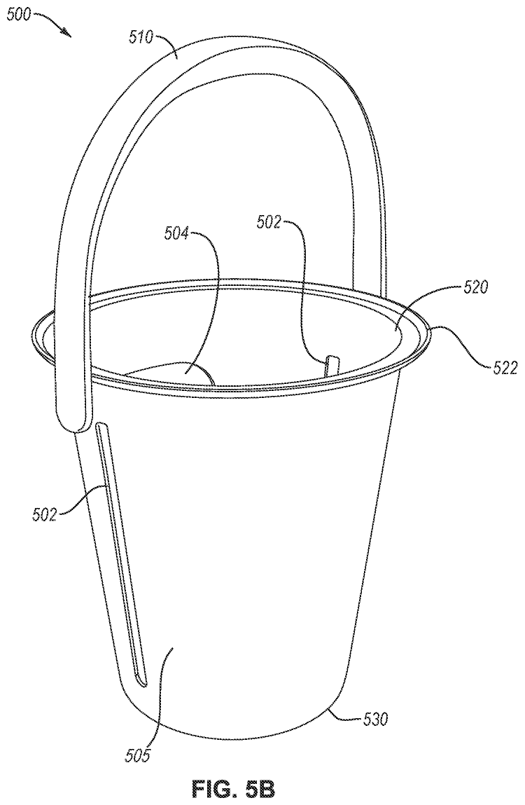

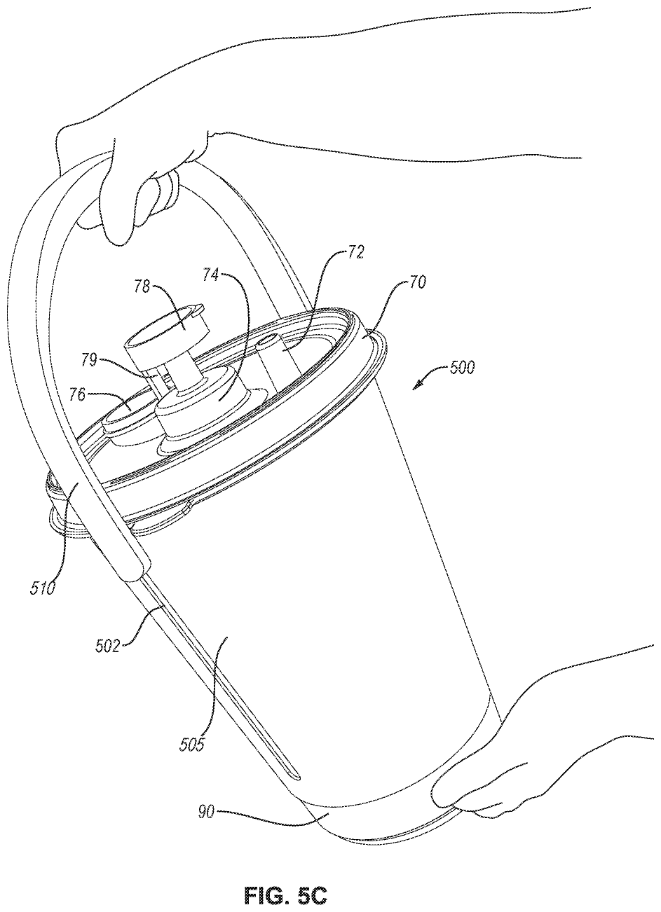

FIG. 5A is an isometric view of a handle accessory 500, according to an embodiment. Unless otherwise noted, the handle accessory 500 may include any aspect of the handle accessory 100 described above. For example, the handle accessory 500 includes a sleeve 505 having a first end region 520 and a second end region 530, elongated openings 502, a gap 504, and/or an outward protruding flange 522 that include aspects of the sleeve 105 having the first end region 120 and the second end region 130, the elongated openings 102, the gap 104, and/or an outward protruding flange 122 described above.

The handle accessory 500 also includes a handle 510. Unless otherwise noted, the handle 510 may include any aspect of the handles 110, 210, 310, 410 described above. The handle 510 includes a single C- or U-shaped handle 510 pivotably or hingedly secured to the sleeve 505 on opposing portions of the first end region 520 of the sleeve 505. In some embodiments, the handle 510 may be secured to the sleeve 505 with each end of the handle 510 proximate to or aligned with the elongated openings 502. The sleeve 505 may include a latch or slot configured to receive a portion of the handle 505 to pivotably secure the handle 510 to the sleeve 505.

FIG. 5A shows the handle 510 in an intermediate position between a downward position resting on or against the sleeve 505 and an upright position. FIG. 5B shows the handle 510 having pivoted to an angled or upright position relative to the intermediate position shown in FIG. 5A. In some embodiments, the handle 510 also may include one or more locking tabs (not shown) positioned on the handle 510 to lock the lid 70 in place when the handle 510 is in the upright position. FIG. 5C shows the handle accessory 500 in use with the urine storage container 90 and the lid 70 secured to the urine storage container 90, with a user carrying the assembly using the handle 510.

FIG. 6A is a cross-sectional view of a portion of a storage container 90 and a portion of a handle accessory 600. Any of the handle accessories 100, 200, 300, 400, 500 may include any aspect of the handle accessory 600 described below. The storage container 90 includes an outward protruding lip 92, and the handle accessory 600 includes a sleeve 605 and an outwardly protruding flange 622. The flange 622 may include a first portion 622a adjacent to the sleeve 605 that interfaces the lip 92 of the storage container 90. The flange 622 also may include a second portion 622b angled upward from the first portion 622a. The second portion 622b may include a tab and at least partially define a channel that mates with at least a portion of the lip 92 such that the lip 92 and the flange 622 form a snap joint configured to releasably secure at least the portion of the lip 92 of the storage container 90 to the handle accessory 600. The second portion 622b may extend entirely around the first portion 622a and/or the sleeve 605, or the second portion 622b may extend only partially around the first portion 622 and/or the sleeve 605 at one or more regions. The snap joint or snap fit of at least a portion of the lip 92 and the second portion 622b of the flange 622 prevents or inhibits the storage container 90 from slipping out of the sleeve 605 as the storage container 90 is tilted and emptied. In some embodiments, the flange 122 may be absent, and the sleeve 605 may include a locking tab at the top, first end of the sleeve 605 configured to releasably secure to the lip 92 of the storage container 90 and prevent the sleeve 605 from sliding down the storage container 90, such as the handle accessory 670 shown in FIG. 6C.

FIG. 6B is a cross-sectional view of a portion of a storage container 90 and a portion of a handle accessory 650. Any of the handle accessories 100, 200, 300, 400, 500 may include any aspect of the handle accessory 650 described below. The handle accessory 650 includes at least a sleeve 655 having one or more rubber portions 660 on an inner surface of the sleeve 650. The one or more rubber portions 660 may include rubber beading. The one or more rubber portions 660 are configured stick to the outer surface of the storage container 90 effective to prevent or inhibit the storage container 90 from slipping out of the sleeve 605 as the storage container 90 is tilted and emptied.

FIG. 6C is an isometric view of a handle accessory 670 including a sleeve 672, a handle 674 pivotably secured to the sleeve 672, and a plurality of locking tabs 676 extending from the sleeve 672. The plurality of locking tabs 676 are sized and configured to releasable secure to lip the lip 92 of the storage container 90 and prevent the sleeve 672 from sliding down the storage container 90. The plurality of locking tabs 676 may include six locking tabs 676 positioned on a top edge of the sleeve 672. In other embodiments, the handle accessory 670 may include one, two, three, four, five, or seven or more locking tabs 672 positioned on the top edge of the sleeve 672. In some embodiments, the plurality of locking tabs 672 may extend from an outer periphery of the sleeve 672. The plurality of tabs 672 also may be included on the handle accessories 100, 200, 300, 400, 500, or 600.

The sleeve 672 of the handle accessory 670 may include any aspect of the sleeves 105, 205, 305, 405, 600, 650 disclosed herein. In some embodiments, the handle accessory 670 includes a length of less than about 2 inches, less than about 1 inch, or about 0.5 inch to about 2 inches. The handle 674 includes a U- or C-shaped handle 674 pivotably or hingedly secured to the sleeve 672 on opposing portions of the sleeve 672. In some embodiments, the handle 674 may include any aspect of the handles 110, 210, 310, 410, 510 disclosed herein.

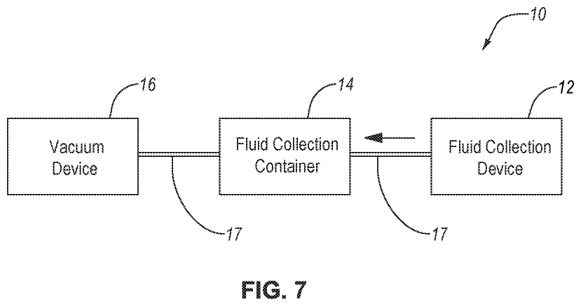

FIG. 7 is a block diagram of a system 10 for fluid storage, according to an embodiment. The system 10 includes a fluid collection device 12, a fluid storage container 14, and a portable vacuum source 16. The fluid collection device 12 may include at least one of any of the handle accessories or the lid accessories described herein. The fluid collection device 12, the fluid storage container 14, and the portable vacuum source 16 may be fluidly coupled to each other via one or more conduits 17. For example, the fluid collection device 12 may be fluidly coupled to the fluid storage container 14 through the port 72, and the portable vacuum source 16 may be fluidly coupled to the fluid storage container 14 through the port 74. The conduit 17 may include any of the conduits described herein, such as conduit 60. The fluid collection device 12 may be operably coupled to one or more of the fluid storage container 14 or the portable vacuum source via the conduit 17. Fluid (e.g., urine or other bodily fluids) collected in the fluid collection device 12 may be removed from the fluid collection device 12 via the conduit 17, which protrudes into an interior region of the fluid collection device 12. For example, a first open end of the conduit 17 may extend into the fluid collection device 12 to a reservoir therein. The second open end of the conduit 17 may extend into the fluid storage container 14 or the portable vacuum source 16. The suction force may be introduced into the interior region of the fluid collection device 12 via the first open end of the conduit 17 responsive to a suction (e.g., vacuum) force applied at the second end of the conduit 17. The suction force may be applied to the second open end of the conduit 17 by the portable vacuum source 16 either directly or indirectly.

The suction force may be applied indirectly via the fluid storage container 14. For example, the second open end of the conduit 17 may be disposed within the fluid storage container 14 and an additional conduit 17 may extend from the fluid storage container 14 to the portable vacuum source 16. Accordingly, the portable vacuum source 16 may apply suction to the fluid collection device 12 via the fluid storage container 14. The suction force may be applied directly via the fluid storage container 14. For example, the second open end of the conduit 17 may be disposed within the portable vacuum source 16. An additional conduit 17 may extend from the portable vacuum source 16 to a point outside of the fluid collection device 12, such as to the fluid storage container 14. In such examples, the portable vacuum source 16 may be disposed between the fluid collection device 12 and the fluid storage container 14. The fluid collection device 12 may be shaped and sized to be positioned adjacent to a urethra.

In some embodiments, the fluid storage container 14 may include a bottle or cup (e.g., collection jar), or any other enclosed container for storing bodily fluids such as urine. In examples, the conduit 17 may extend from the fluid collection device 12 and attach to the fluid storage container 14 at a first point therein, such as the port 72. An additional conduit 17 may attach to the fluid storage container 14 at a second point thereon, such as the port 74, and may extend and attach to the portable vacuum source 16. For example, the fluid storage container 14 may include a container fluidly coupled to a first conduit section that is also fluidly coupled to the fluid collection member of the fluid collection device 12. The container may be fluidly coupled to a second section of the conduit 17 that is also fluidly coupled to a portable vacuum source. In such examples, the portable vacuum source 16 may provide a vacuum/suction through the container to the fluid collection member to provide suction in the chamber of the fluid collection member. Accordingly, a vacuum (e.g., suction) may be drawn through fluid collection device 12 via the fluid storage container 14. As the fluid is drained from the chamber, the fluid may travel through the first section of conduit to the fluid storage container where it may be retained. Fluid, such as urine, may be drained from the fluid collection device 12 using the portable vacuum source 16.

In some embodiments, the portable vacuum source 16 may be disposed in or on the fluid collection device 12. In such examples, the conduit 17 may extend from the fluid collection device and attach to the portable vacuum source 16 at a first point therein. An additional conduit 17 may attach to the portable vacuum source 16 at a second point thereon and may extend out of the fluid collection device 12, and may attach to the fluid storage container 14. Accordingly, a vacuum (e.g., suction) may be drawn through fluid collection device 12 via the fluid storage container 14.

The portable vacuum source 16 may include one or more of a manual vacuum pump, and electric vacuum pump, a diaphragm pump, a centrifugal pump, a displacement pump, a magnetically driven pump, a peristaltic pump, or any pump configured to produce a vacuum. The portable vacuum source 16 may provide a vacuum or suction to remove fluid from the fluid collection member of the fluid collection device 12. In some embodiments, the portable vacuum source 16 may be powered by one or more of a power cord (e.g., connected to a power socket), one or more batteries, or even manual power (e.g., a hand operated vacuum pump). In examples, the portable vacuum source 16 may be sized and shaped to fit outside of, on, or within the fluid collection device 12. For example, the portable vacuum source 16 may include one or more miniaturized pumps or one or more micro pumps. In some embodiments, the vacuum source 16 includes a stationary vacuum source, such as a wall-mounted vacuum source. The portable vacuum sources 16 disclosed herein may include one or more of a switch, a button, a plug, a remote, or any other device suitable to activate the portable vacuum source 16. It should be understood that the portable vacuum sources 16 disclosed herein may provide a portable means of providing a suction or vacuum that allows use of the devices and systems herein outside of hospital or care facility environments where vacuum lines are plumbed into patient rooms or large (e.g., larger or heavier than a patient can readily carry) vacuum sources are located. For example, a portable vacuum source may be small and light enough to be carried by a user (e.g., patient) or aid (e.g., nurse) during transportation of the user.

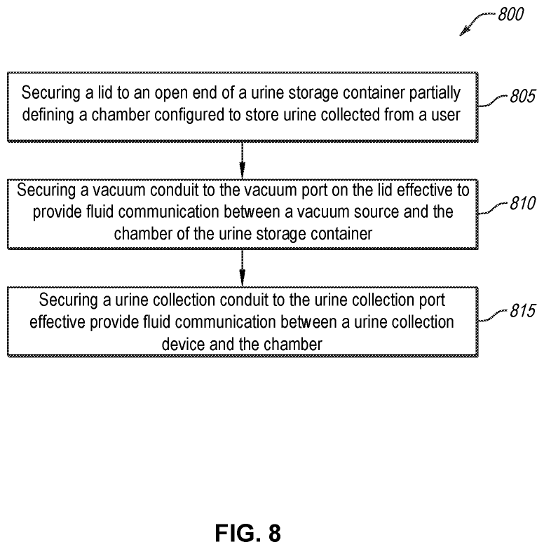

FIG. 8 is a flow diagram of a method 800 of assembling a urine storage system for storing and disposing of urine collected from a user. The method 800 may include any system described herein. In an embodiment, the method 800 includes an act 805 of securing a lid to an open end of a urine storage container at least partially defining a chamber configured to store urine collected from a user. The lid includes a vacuum port, a urine collection port, a urine disposal port sized and dimensioned to pour the urine in the urine storage container therethrough, and a cap secured to the urine disposal port. The method 800 includes an act 810 of securing a vacuum conduit to the vacuum port on the lid effective to provide fluid communication between a vacuum source and the chamber of the urine storage container. The method 800 includes an act 815 of securing a urine collection conduit to the urine collection port effective provide fluid communication between a urine collection device and the chamber such that urine collected from the user enters the chamber of the urine storage container through the urine collection port when the vacuum source is activated.

In some embodiments, the method 800 includes an act of inserting at least a first portion of the urine storage container into a sleeve of a handle accessory. The sleeve may be shaped complementary to at least the first portion of the urine storage container and include at least one handle. The method 800 also may include an act of positioning a second portion of the urine storage container in a base having a recessed portion sized and shaped complementary to the second portion of the urine storage container. The vacuum source may include a portable vacuum source housed by a body that includes that base. In some embodiments, the sleeve includes at least one elongated opening extending at least partially between the first end region and the second end region. The sleeve may include an outer periphery and a gap in the outer periphery extending longitudinally from the second end region at least halfway to the first end region and extending at least about 75 degrees around the outer periphery of the sleeve. In some embodiments, the at least one handle may include a single handle positioned substantially opposite to the gap and the sleeve may include two elongated openings positioned substantially opposite to one another between the gap and the single handle. The at least one handle may include a single handle pivotably secured to the opposing portions of the first end region of the sleeve. In some embodiments, the at least one handle may include two handles positioned opposite to one another, the gap may be positioned between the two handles, and/or the at least one elongated opening may be positioned between the two handles distal to the gap. The two handles may be pivotably secured to the sleeve.

In some embodiments, the method 800 may include an act of snap fitting one or more tabs on the sleeve around at least a portion of an outward protruding lip on the urine storage container. In these and other embodiments, the act of inserting the urine storage container into a sleeve of a handle accessory may include inserting the urine storage container into the sleeve of the handle accessory until the outward protruding lip interfaces an outward protruding flange on the handle accessory. The sleeve may include one or more rubber surfaces on an inner portion of the sleeve positioned to interface the urine storage container. In some embodiments, the method 800 may include an act of engaging a locking tab on the sleeve with a lip on the storage container.

Acts 805, 810, and 815 of the method 800 are for illustrative purposes. For example, the act 805, 810, and 815 of the method 800 may be performed in different orders, split into multiple acts, modified, supplemented, or combined. In an embodiment, one or more of the acts 805, 810, and 815 of the method 800 may be omitted from the method 800. Any of the acts 805, 810, and 815 may include using any of the fluid collection devices or systems disclosed herein.

As used herein, the term “about” or “substantially” refers to an allowable variance of the term modified by “about” by ±10% or ±5%. Further, the terms “less than,” “or less,” “greater than”, “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiment disclosed herein are for purposes of illustration and are not intended to be limiting.

What is claimed is:

1. A urine storage assembly for storing and disposing of urine collected from a user, the urine storage assembly comprising:
a urine storage container configured to store urine collected from the user and having an open end and a closed end distal to the open end;
a lid secured or securable to the open end of the urine storage container, the lid including a vacuum port configured to attach to a vacuum conduit in fluid communication with a vacuum source, a urine collection port configured to attach to a urine collection conduit in fluid communication with a urine collection device such that urine collected from the user enters the urine storage container through the urine collection port when the vacuum source is activated, a urine disposal port sized and dimensioned to pour urine in the urine storage container therethrough when the lid is secured to the urine storage container, and a cap secured or securable to the urine disposal port; and
a handle accessory including a sleeve and at least one handle, the sleeve being shaped and sized complimentary to at least a portion of the urine storage container.

2. The urine storage assembly of claim 1, wherein:
the urine storage container tapers at least partially between the open end and the closed end; and
the sleeve of the handle system includes a first end region, a second end region, an outer periphery, at least one elongated opening extending at least partially between the first end region and the second end region, and a gap in the outer periphery extending longitudinally from the second end region at least halfway to the first end region and extending at least about 75 degrees around the outer periphery of the sleeve, the sleeve tapering between the first end region and the second end region complementary to urine storage container.

3. The urine storage assembly of claim 2, wherein the at least one handle includes a single handle positioned substantially opposite to the gap and the sleeve includes two elongated openings positioned substantially opposite to one another between the gap and the single handle.

4. The urine storage assembly of claim 2, wherein the at least one handle includes a single handle pivotably secured to the opposing portions of the first end region of the sleeve.

5. The urine storage assembly of claim 2, wherein the at least one handle includes two handles positioned opposite to one another, the gap is positioned between the two handles, and the at least one elongated opening is positioned between the two handles distal to the gap.

6. The urine storage assembly of claim 5, wherein the two handles are pivotably secured to the sleeve.

7. The urine storage assembly of claim 6, wherein at least one handle of the two handles includes a locking tab and is pivotable from an unlocked position to a locked position, the locking tab being configured to engage with the lid effective to releasably lock the lid on the urine storage container when the at least one handle is in the locked position.

8. The urine storage assembly of claim 1, wherein:
the urine storage container includes an outward protruding lip proximate to the open end; and
the handle accessory includes an outward protruding flange proximate to the first end region and interfacing the lip of the urine storage container.

9. The urine storage assembly of claim 8, wherein the sleeve includes one or more rubber surfaces on an inner portion of the sleeve positioned to interface the urine storage container.

10. The urine storage assembly of claim 8, wherein the first end region of the sleeve includes one or more tabs configured to snap fit around at least a portion of the lip of the urine storage container.

11. The urine storage assembly of claim 1, wherein the urine disposal port defines an opening having a diameter of about 1 inch to about 1.5 inches.

12. The urine storage assembly of claim 1, wherein the cap is configured to close the urine disposal port in a closed position and close the second port in an open position.

13. The urine storage assembly of claim 1, further comprising a locking tab on the sleeve engaged with a lip on the storage container.

14. A urine storage system for storing and disposing of urine collected from a user, the urine storage system comprising:
a urine storage container at least partially defining a chamber configured to store urine collected from the user and having an open end and a closed end distal to the open end;
a lid secured or securable to the open end of the urine storage container, the lid including a vacuum port, a urine collection port, a urine disposal port sized and dimensioned to pour the urine in the urine storage container therethrough when the lid is secured to the urine storage container, and a cap secured or securable to the urine disposal port;
a vacuum conduit in fluid communication with a vacuum source and attached to the vacuum port effective to provide fluid communication between the vacuum source and the chamber of the urine storage container; and
a urine collection conduit in fluid communication with a urine collection device and attached to the urine collection port effective to provide fluid communication between the chamber and the urine collection device such that urine collected from the user enters the chamber of the urine storage container through the urine collection port when the vacuum source is activated.

15. The urine storage system of claim 14, further comprising:
a base having a recessed portion sized and shaped complementary to the second end of the urine storage container;
a portable vacuum system including a body housing the vacuum source and the base; and
a handle accessory including a sleeve and at least one handle, the sleeve being shaped and sized complimentary to at least a portion of the urine storage container.

16. The urine storage system of claim 15, wherein:
the urine storage container tapers at least partially between the open end and the closed end; and
the sleeve of the handle system includes a first end region and a second end region, and the sleeve tapers between the first end region and the second end region complementary to urine storage container.

17. The urine storage system of claim 16, wherein:
the sleeve includes at least one elongated opening extending at least partially between the first end region and the second end region; and
the sleeve includes an outer periphery and a gap in the outer periphery extending longitudinally from the second end region at least halfway to the first end region and extending at least about 75 degrees around the outer periphery of the sleeve.

18. The urine storage system of claim 17, wherein the at least one handle includes a single handle positioned substantially opposite to the gap and the sleeve includes two elongated openings positioned substantially opposite to one another between the gap and the single handle.

19. The urine storage system of claim 17, wherein the at least one handle includes a single handle pivotably secured to the opposing portions of the first end region of the sleeve.

20. The urine storage system of claim 17, wherein the at least one handle includes two handles positioned opposite to one another, the gap is positioned between the two handles, and the at least one elongated opening is positioned between the two handles distal to the gap.

21. The urine storage system of claim 20, wherein the two handles are pivotably secured to the sleeve.

22. The urine storage system of claim 15, wherein:
the urine storage container includes an outward protruding lip proximate to the open end;
the handle accessory includes an outward protruding flange proximate to the first end region and interfacing the lip of the urine storage container;
the sleeve includes one or more rubber surfaces on an inner portion of the sleeve positioned to interface the urine storage container; and
the first end region of the sleeve includes one or more tabs configured to snap fit around at least a portion of the lip of the urine storage container.

23. The urine storage system of claim 15, further comprising a locking tab on the sleeve engaged with a lip on the storage container.

24. The urine storage system of claim 14, wherein the urine disposal port defines an opening having a diameter of about 1 inch to about 1.5 inches.

25. The urine storage system of claim 14, wherein the cap is configured to close the urine disposal port in a closed position and close the second port in an open position.

26. A method of assembling a urine storage system for storing and disposing of urine collected from a user, the method comprising:
securing a lid to an open end of a urine storage container at least partially defining a chamber configured to store urine collected from a user, the lid including a vacuum port, a urine collection port, a urine disposal port sized and dimensioned to pour the urine in the urine storage container therethrough, and a cap secured to the urine disposal port;
securing a vacuum conduit to the vacuum port on the lid effective to provide fluid communication between a vacuum source and the chamber of the urine storage container; and
securing a urine collection conduit to the urine collection port effective provide fluid communication between a urine collection device and the chamber such that urine collected from the user enters the chamber of the urine storage container through the urine collection port when the vacuum source is activated.

27. The method of claim 26, further comprising inserting at least a first portion of the urine storage container into a sleeve of a handle accessory, the sleeve being shaped complementary to at least the first portion of the urine storage container and including at least one handle.

28. The method of claim 27, further comprising positioning a second portion of the urine storage container in a base having a recessed portion sized and shaped complementary to the second portion of the urine storage container, wherein the vacuum source includes a portable vacuum source housed by a body that includes that base.

29. The method of claim 27, wherein:
the sleeve includes at least one elongated opening extending at least partially between the first end region and the second end region; and
the sleeve includes an outer periphery and a gap in the outer periphery extending longitudinally from the second end region at least halfway to the first end region and extending at least about 75 degrees around the outer periphery of the sleeve.

30. The method of claim 29, wherein the at least one handle includes a single handle positioned substantially opposite to the gap and the sleeve includes two elongated openings positioned substantially opposite to one another between the gap and the single handle.

31. The method of claim 29, wherein the at least one handle includes a single handle pivotably secured to the opposing portions of the first end region of the sleeve.

32. The method of claim 29, wherein the at least one handle includes two handles positioned opposite to one another, the gap is positioned between the two handles, and the at least one elongated opening is positioned between the two handles distal to the gap.

33. The method of claim 32, wherein the two handles are pivotably secured to the sleeve.

34. The method of claim 27, further comprising:
snap fitting one or more tabs on the sleeve around at least a portion of an outward protruding lip on the urine storage container; and
wherein inserting the urine storage container into a sleeve of a handle accessory includes inserting the urine storage container into the sleeve of the handle accessory until the outward protruding lip interfaces an outward protruding flange on the handle accessory, the sleeve including one or more rubber surfaces on an inner portion of the sleeve positioned to interface the urine storage container.

35. The method of claim 27, further comprising engaging a locking tab on the sleeve with a lip on the storage container.
